(19) United States
(12) Patent Application Publication
(10) Pub. No.: US 2002/0094805 A1
(43) Pub. Date: Jul. 18, 2002

(54) Mobile communications system, communication control method therefor and communication control program

(75) Inventors: Hidekazu Yano, Tokyo (JP); Takeshi Fukushi, Tokyo (JP)

Correspondence Address: SUGHRUE, MION, ZINN MACPEAK & SEAS, PLLC, 2100 Pennsylvania Avenue, N.W., Washington, DC, 20037-3202, US

(73) Assignee: NEC CORPORATION

(21) Appl. No.: 10/043,328

(22) Filed: Jan. 14, 2002

(30) Foreign Application Priority Data
Jan. 17, 2001 (JP) 2001-009420

(51) Int. Cl. H04M 3/42

(52) U.S. Cl. 455/414; 455/456; 455/433; 455/550

(57) ABSTRACT

A mobile communications system is provided that automatically restricts a portable communications terminal which conducts communications at places such as hospitals where the uses of portable communications terminals are prohibited. A mobile communications system, which controls mobile communications of user terminals, includes a use prohibition area registration table, a location information management table, and a terminal location manager. The use prohibition area registration table records location data about locations within a use prohibition area where communications of the user terminal is not allowed. The location information management table records data about a current location of each user terminal, informed from the user terminal. The terminal location manager detects a user terminal within a use prohibition area based on data on the use prohibition area registration table and based on data on the location information management table and controls such that the user terminal does not communicate within the use prohibition area. Each user terminal includes a location detector for detecting a current location of the user terminal, and means for notifying the communication limiter of data about the current location of the user terminal detected by the location detector.

### BACKGROUND OF THE INVENTION

The present invention relates to mobile communications for portable telephones. Particularly, the present invention relates to a mobile communications system, a communication control method therefor, and a communication control program, each having the function of automatically limiting communications at specific places such as hospitals.

Recently, portable communications systems such as portable (cellular) telephones and PHSs (Personal Handy Phones) are becoming increasingly common and being used by many subscribers. However, because communication portable terminals such as portable telephones and PHSs radiate radio waves, attention should be taken to the places where they are used.

### SUMMARY OF THE INVENTION

The present invention is made to solve the above-mentioned drawbacks in the prior art. An object of the present invention is to provide a mobile communications system that can prevent an occurrence of radio-wave troubles by setting a specific place as a use prohibition area, monitoring a portable communications terminal conducting communications in the place, and automatically limiting the communications.

Another object of the present invention is provide a communication control method for a mobile communication system, that can prevent an occurrence of radio-wave troubles by setting a specific place as a use prohibition area, monitoring a portable communications terminal conducting communications in the place, and automatically limiting the communications.

Further another object of the present invention is to provide a communication control program that can prevent an occurrence of radio-wave troubles by setting a specific place as a use prohibition area, monitoring a portable communications terminal conducting communications in the place, and automatically limiting the communications.

In order to accomplish the above-mentioned objects, a mobile communications system of the present invention, which controls mobile communications of a user terminal, comprises a communication limiter for limiting communications of the user terminal in accordance with a location of the user terminal. The user terminal having a disconnection processor disconnects communications of the user terminal based on instructions from the communication limiter.

In the mobile communications system, the user terminal comprises a location detector for detecting a current location of the user terminal and means for notifying the communication limiter of data about the current location of the user terminal detected by the location detector.

In the mobile communications system, the communication limiter comprises a use prohibition area registration table for recording location data about a location within a use prohibition area where communications of the user terminal is not allowed; a location information management table for recording data about a current location of the user terminal, notified from the user terminal; and a terminal location manager for detecting the user terminal within the use prohibition area based on data on the use prohibition area registration table and based on data on the location information management table, and controlling such that the user terminal does not communicate within the use prohibition area.

In the mobile communications system, when the user terminal currently in a busy state is detected within the use prohibition area, the communication limiter instructs the disconnection processor in the user terminal to disconnect communications. When receiving a communication disconnection instruction from the communication limiter in a busy state, the disconnection processor disconnects communications of the user terminal.

In the mobile communications system, when it is detected that the user terminal currently in a busy state is approaching the use prohibition area, the communication limiter notifies the user terminal of the fact. The disconnection processor urges a user to disconnect communications by issuing an alarm when the communication limiter notifies, in a busy state, the disconnection processor that the user is approaching the use prohibition area.

In the mobile communications system, when a user terminal currently within the use prohibition area originates a call to another communication terminal, the communication limiter notifies the user terminal that the user terminal is within the use prohibition area, without connecting the call origination.

In the mobile communications system, when a user terminal currently within the use prohibition area originates a call to another communication terminal, the communication limiter notifies the communication terminal, or a call originator, that the user terminal, or a communication destination, is within the use prohibition area, without connecting the call origination.

In the mobile communications system, the location detector detects a current location of the user terminal, using a global positioning system (GPS).

In the mobile communications system, the function of said communication limiter is integrated within a home location register (HLR).

Another aspect of the present invention, a home location register (HLR) in a mobile communications system comprises means for limiting communications of a user terminal in accordance with a location of the user terminal.

According to the present invention, the home location register further comprises means for receiving data about a current location of the user terminal; a use prohibition area registration table for recording location data about a location within a use prohibition area where communications of the user terminal is not allowed; a location information management table for recording data about a current location of the user terminal, notified from the user terminal; and a terminal location manager for detecting the user terminal within the use prohibition area based on data on the use prohibition area registration table and based on data on the location information management table, and controlling such that the user terminal does not communicate within the use prohibition area.

In the home location register, when the user terminal currently in a busy state is detected within the use prohibition area, the disconnection processor in the user terminal is instructed to disconnect communications.

In the home location register, when it is detected that the user terminal currently in a busy state is approaching the use prohibition area, the user terminal is notified of the fact.

In the home location register, when a user terminal currently within the use prohibition area originates a call to another communication terminal, the user terminal is notified that the user terminal is within the use prohibition area, without connecting the call origination.

In the home location register, when a user terminal currently within the use prohibition area originates a call to another communication terminal, the communication terminal, or a call originator, is notified that the user terminal, or a communication destination, is within the use prohibition area, without connecting the call origination.

According to further another aspect of the present invention, a mobile communication control method, wherein mobile communications of a user terminal are controlled, comprises the step of limiting communications of a user terminal in accordance with a location of the user terminal. The mobile communication control method further comprises the steps of receiving data about a current location of the user terminal; referring to a use prohibition area registration table for recording location data about a location within a use prohibition area where communications of the user terminal is not allowed; referring to a location information management table for recording data about a current location of the user terminal; and performing a terminal location management wherein the user terminal within the use prohibition area is detected based on data on the use prohibition area registration table and based on data on the location information management table, and control is made such that the user terminal does not communicate within the use prohibition area.

Moreover, the communication control method further comprises the step of instructing, when the user terminal currently in a busy state is detected within the use prohibition area, the disconnection processor in the user terminal to disconnect communications.

Moreover, the communication control method further comprises the step of notifying, when it is detected that the user terminal currently in a busy state is approaching the use prohibition area, the user terminal of the fact.

Moreover, the communication control method further comprises the step of notifying, when a user terminal currently within the use prohibition area originates a call to another communication terminal, the user terminal that the user terminal is within the use prohibition area, without connecting the call origination.

Moreover, the communication control method further comprises the step of notifying, when a user terminal currently within the use prohibition area originates a call to another communication terminal, the communication terminal, or a call originator, that the user terminal, or a communication destination, is within the use prohibition area, without connecting the call origination.

Another aspect of the present invention relates to a communication control program that controls mobile communications of a user terminal by controlling a computer. The program executes the process of limiting communications of a user terminal in accordance with a location of the user terminal.

According to another aspect of the present invention, a portable communications terminal for mobile communications comprises a disconnection processor for disconnecting communications based on instructions from a communication limiter. The limiter limits communications of the portable communications terminal in accordance with a location of the portable communications terminal.

Moreover, the portable communications terminal further comprises a location detector for detecting a current location of the portable communications terminal and means for notifying the communication limiter of data about the current location of the communications terminal detected by the location detector.

In the portable communications terminal of the present invention, the disconnection processor urges a user to disconnect communications by issuing an alarm when said disconnection processor receives the notice that the terminal is currently approaching the use prohibition area, from the communication limiter in a busy state.

In the portable communications terminal, the location detector detects a current location of the personal communication terminal, using a global positioning system (GPS).

### BRIEF DESCRIPTION OF THE DRAWINGS

This and other objects, features and advantages of the present invention will become more apparent from the following detailed description taken in conjunction with the attached drawings, in which:

FIG. 1 is a block diagram illustrating the configuration of a mobile communications system according to a first embodiment of the present invention;

FIG. 2 is a diagram illustrating an example of a use prohibition area registration table according to the first embodiment of the present invention;

FIG. 3 is a diagram illustrating an example of a location registration information management table according to the first embodiment of the present invention;

FIG. 4 is a diagram explaining a communication restriction process according to the first embodiment of the present invention;

FIG. 5 is a flowchart explaining a communication disconnection process when a user terminal enters a use prohibition area, according to the first embodiment of the present invention;

FIG. 6 is a flowchart explaining a process when a terminal within a use prohibition area originates a call, according to the first embodiment of the present invention; and

FIG. 7 is a flowchart explaining a process when another terminal originates a call to a terminal within a use prohibition area, according to the first embodiment of the present invention.

### DESCRIPTION OF THE EMBODIMENTS

An example of the present invention will be described by referring to the attached drawings.

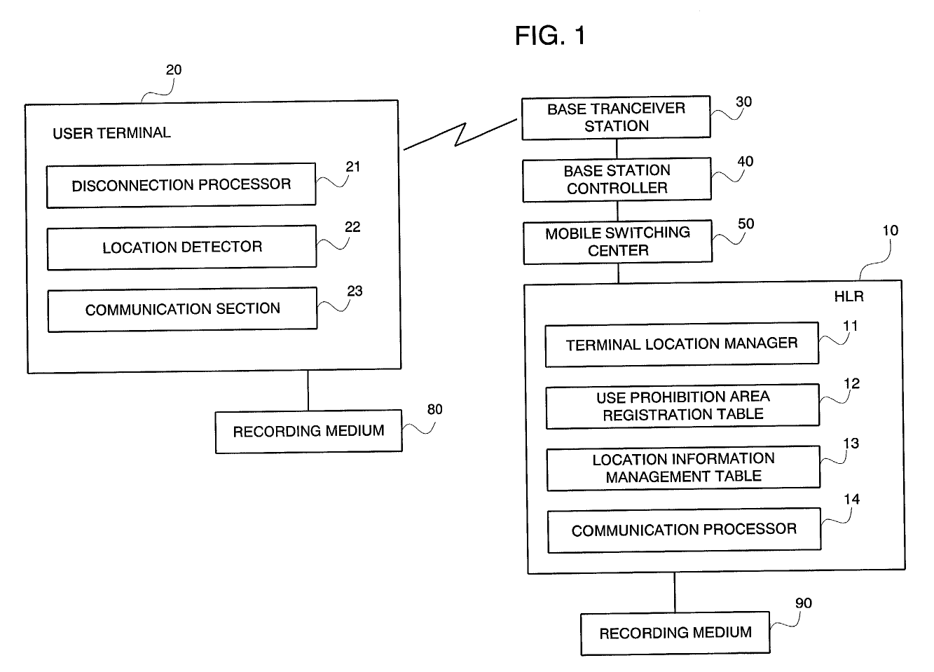

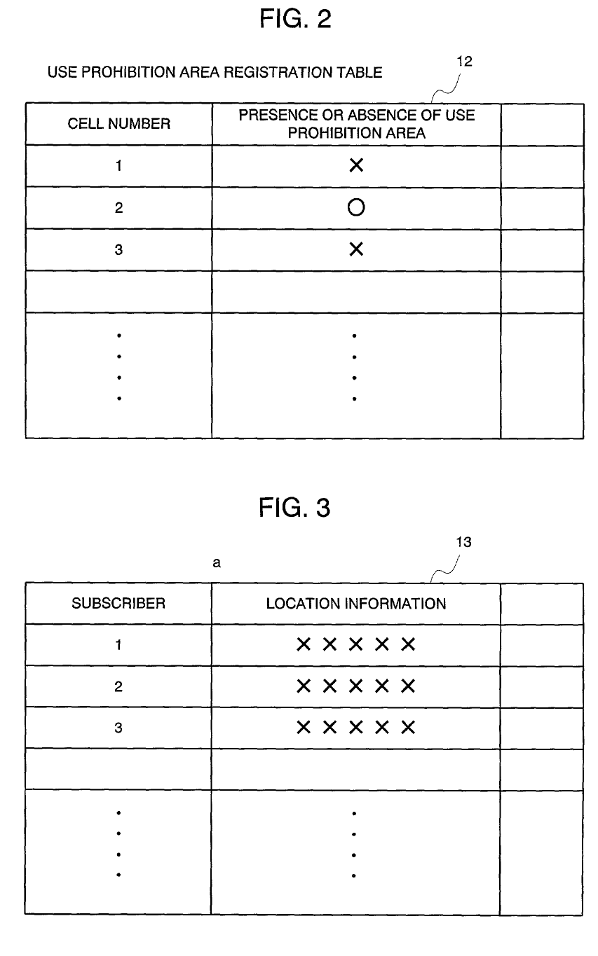

FIG. 1 is a block diagram explaining the configuration of a mobile communications terminal according to a first embodiment of the present invention.

In the mobile communications terminal shown in FIG. 1, a home location register (HLR) 10 detects whether or not a user terminal 20, or a personal communication terminal, of a user is within a use prohibition area. Then, controls necessary controls are exercised to restrict communications/conversations.

The user terminal 20 corresponds to a portable telephone, a PHS, or other terminal for mobile communications.

Referring to FIG. 1, the user terminal 20 are connected to the HLR 10 through a base transceiver station (BTS) 30, a base station controller (BSC) 40, and a mobile switching center (MSC) 50. The HLR 10 transmits and receives data and instructions, each which restricts communications of the user terminal 20 via these nodes.

The user terminal 20 includes a communications section 23 for processing the mobile communications, a location detector 22 for detecting the location of the user terminal 20, and a disconnection processor 21 for executing processes, for example, communication disconnection or alarm, based on instructions from the HLR. The location detector 22, which has, for example, the function of a global positioning system (GPS), can detect the location of the user terminal 20. The current location of the user terminal 20 detected by the location detector 22 is transmitted to and informed the HLR 10.

The HLR 10 includes a communication processor 14 for processing communications as a common HLR, a use prohibition area registration table 12 for registering use prohibition areas where communications are not allowed, a location information management table 13 for registering a current location informed from each user terminal 20, and a terminal location manager 11 for judging the relationships between each user terminal 20 and use prohibition areas based on data on the tables 12 and 13 and transmitting instructions necessary to restrict communications, to the user terminal 20.

Next, the process of the communications system in the present embodiment will be described below.

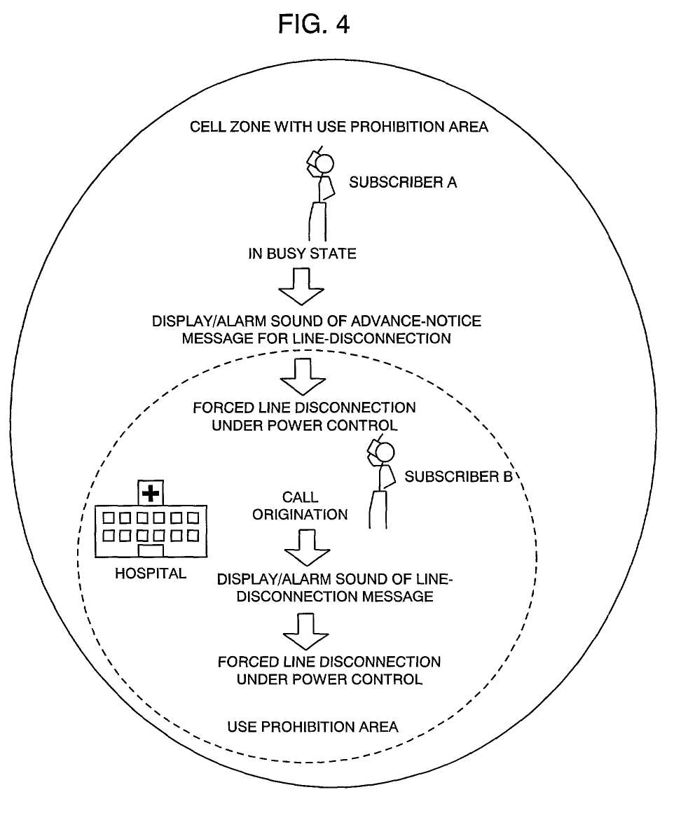

FIG. 4 is a diagram explaining the communication restriction process according to the present embodiment.

First, the HLR 10 judges whether or not the user terminal 20 is within a cell where a use prohibition area exists. When there is a location registration request to the HLR 10, the judgement is made by referring to cell information indicating the location of the user terminal 20 contained in the location registration information as well as the use prohibition area registration table.

When recognizing that the user terminal 20 is within the cell where a use prohibition area exists, the HLR 10 begins gathering the information on the location of the user terminal 20. The HLR 10 monitors the relative location between the use prohibition area and the user terminal 20 while referring to the terminal location information management table 13.

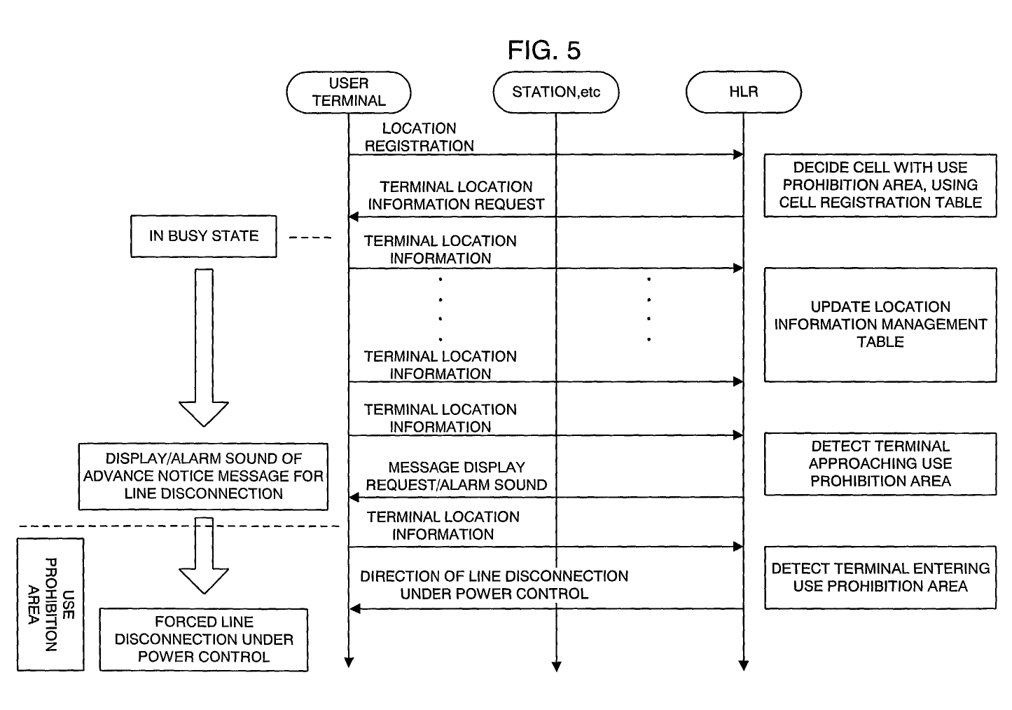

FIG. 5 is a flowchart explaining a communication disconnection process when a user terminal enters a use prohibition area, in the embodiment.

Referring to FIG. 5, when the subscriber A, which is talking over the user terminal 20, enters a use prohibition area, the HLR 10 recognizes such a fact and informs the user terminal 20 of it. Then, the disconnection processor 21 in the user terminal 20 issues an alarm sound and displays a message saying that “You are approaching a use prohibition area, please power off” on the user terminal 20. Thus, the disconnection processor 21 urges the subscriber A to pay an attention and to cut off the power.

If the user terminal A enters an use prohibition area with the power source of the user terminal 20 powered on, the disconnection processor 21 disconnects the line with the transmission power suppressed under power control.

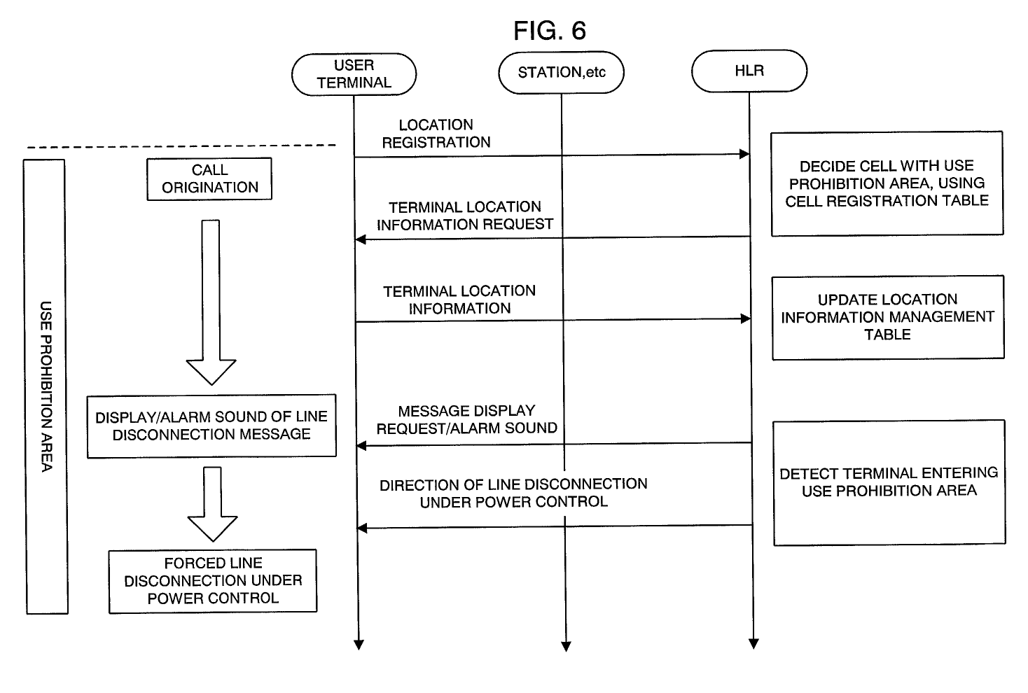

FIG. 6 is a flowchart explaining the process of originating a call from a terminal within a use prohibition area, in the embodiment.

Referring to FIG. 6, when the subscriber B within a use prohibition area originates a call from the user terminal 20, the HLR 10 recognizes the call origination, thus disconnecting the call origination to a communication destination. Similarly to the embodiment in FIG. 5, the HLR 10 controls the user terminal 20 to issue an alarm sound and to display a message such as “origination is prohibited because of an use prohibition area”. Moreover, the HLR 10 disconnects the line while the transmission power from the terminal is suppressed under power control.

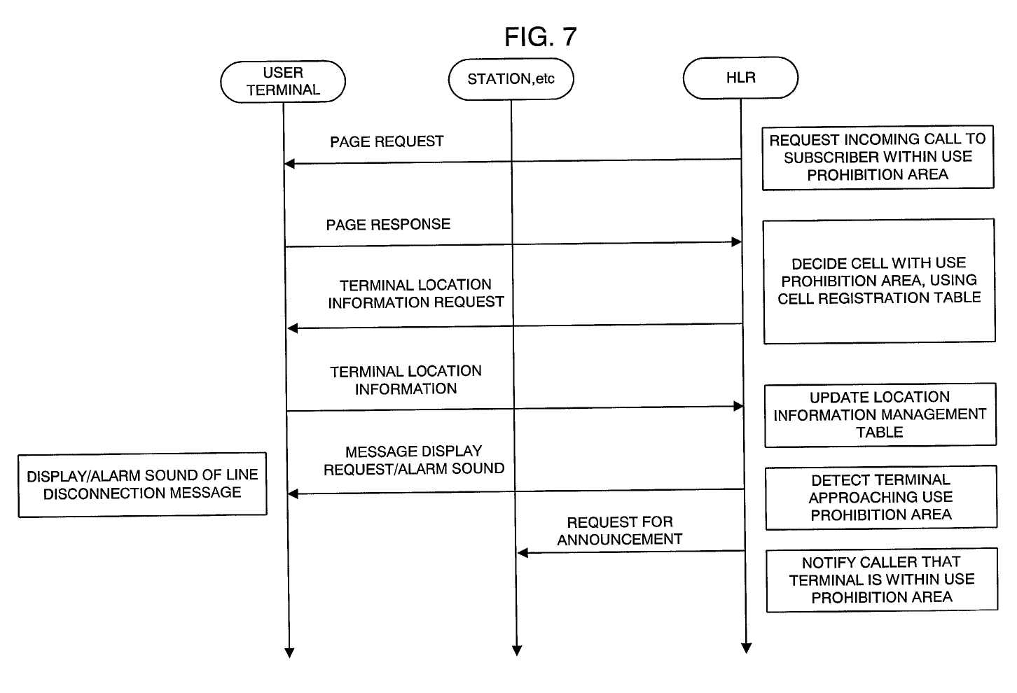

FIG. 7 is a flowchart explaining the process of originating a call from another terminal to a terminal within a use prohibition area, in the present embodiment.

Referring to FIG. 7, when a call origination occurs from another terminal to the user terminal 20 of a subscriber within a use prohibition area, the HLR 10 recognizes it, thus preventing the call origination from being connected to the user terminal 20 within the use prohibition area. By gathering location information from the page response having the location information of the user terminal 20 based on the message signal, the HLR 10 recognizes the location of the user terminal 20 on the incoming call side. The HLR 10 informs the call originator of being within a use prohibition area.

As described above, in the mobile communications system of the present embodiment, a use prohibition area can be created even in part of within each cell. As a result, the mobile communications system can automatically control such that the user terminal 20 does not conduct its communications within the use prohibition area.

In the first embodiment, the HLR 10 implements the process of restricting communications of the user terminal 20. However, the present invention should not be limited to only the first embodiment. Alternatively, the communication limiter including the terminal location manager 11, the use prohibition area registration table 12, and the location information management table 13, inside the HLR 10, may be prepared externally to restrict the communications of the user terminal 20.

In the mobile communications system, the function of the terminal location manager in the HLR 10 (or a communication limiter), the function of the disconnection processor 21 in the user terminal 20, and other functions can be realized in hardware. Alternatively, the mobile communications system can be realized by loading the computer program having the above-mentioned respective functions into the memory of the computer processor. The computer program is stored into magnetic disks, semiconductor memories, or other memory media 80 and 90. The computer program is loaded from the memory medium to the computer processor. The above-mentioned functions can be realized by controlling the operation of the computer processor.

As described above, the present invention has been described together with the preferred embodiments. However, it should be noted that the present invention is not limited only to the embodiments. Various modifications can be realized within the scope of the technical concept of the present invention.

As described above, in the mobile communications system, a use prohibition area may be set even in part of each cell. Thus, the mobile communications system can automatically control such that a user cannot use his or her portable communication terminal within the use prohibition area.

In such a configuration, even part of a cell zone can be set as a portable telephone use prohibition area. Thus, the mobile communications system monitors a portable communications terminal that conducts communications within the prohibition area and automatically prohibits telephone conversations. As a result, the occurrence of radio wave trouble can be prevented.

The entire disclosure of Japanese Application No. 2001-009420 filed on Jan. 17, 2001 including specification, claims, drawings and summary are incorporated herein by reference in its entirely.

What is claimed is:

1 A mobile communications system wherein mobile communications of a user terminal is controlled, said system comprising:
a communication limiter for limiting communications of said user terminal in accordance with a location of said user terminal;
said user terminal having a disconnection processor for disconnecting communications of said user terminal based on instructions from said communication limiter.

2 The system defined in claim 1, wherein said user terminal comprises:
a location detector for detecting a current location of said user terminal; and
means for notifying said communication limiter of data about the current location of said user terminal detected by said location detector.

3 The system defined in claim 2, wherein said communication limiter comprises:
a use prohibition area registration table for recording location data about a location within a use prohibition area where communications of said user terminal is not allowed;
a location information management table for recording data about a current location of said user terminal, notified from said user terminal; and
a terminal location manager for detecting said user terminal within said use prohibition area based on data on said use prohibition area registration table and based on data on said location information management table, and controlling such that said user terminal does not communicate within said use prohibition area.

4 The system defined in claim 3, wherein when said user terminal currently in a busy state is detected within said use prohibition area, said communication limiter instructs said disconnection processor in said user terminal to disconnect communications and wherein when receiving a communication disconnection instruction from said communication limiter in a busy state, said disconnection processor disconnects communications of said user terminal.

5 The system defined in claim 4, wherein when it is detected that said user terminal currently in a busy state is approaching said use prohibition area, said communication limiter notifies said user terminal of the fact and wherein said disconnection processor urges a user to disconnect communications by issuing an alarm when said communication limiter notifies, in a busy state, said disconnection processor that said user is approaching said use prohibition area.

6 The system defined in claim 4, wherein when a user terminal currently within said use prohibition area originates a call to another communication terminal, said communication limiter notifies said user terminal that said user terminal is within said use prohibition area, without connecting said call origination.

7 The system defined in claim 4, wherein when a user terminal currently within said use prohibition area originates a call to another communication terminal, said communication limiter notifies said communication terminal, or a call originator, that said user terminal, or a communication destination, is within said use prohibition area, without connecting said call origination.

8 The system defined in claim 2, wherein said location detector detects a current location of said user terminal, using a global positioning system (GPS).

9 The system defined in claim 1, wherein the function of said communication limiter is integrated within a home location register (HLR).

10 A home location register (HLR) in a mobile communications system, comprises:
means for limiting communications of a user terminal in accordance with a location of said user terminal.

11 The home location register defined in claim 10, further comprising:
means for receiving data about a current location of said user terminal;
a use prohibition area registration table for recording location data about a location within a use prohibition area where communications of said user terminal is not allowed;
a location information management table for recording data about a current location of said user terminal, notified from said user terminal; and
a terminal location manager for detecting said user terminal within said use prohibition area based on data on said use prohibition area registration table and based on data on said location information management table, and controlling such that said user terminal does not communicate within said use prohibition area.

12 The home location register defined in claim 11, wherein when said user terminal currently in a busy state is detected within said use prohibition area, said disconnection processor in said user terminal is instructed to disconnect communications.

13 The home location register defined in claim 12, wherein when it is detected that said user terminal currently in a busy state is approaching said use prohibition area, said user terminal is notified of the fact.

14 The home location register defined in claim 12, wherein when a user terminal currently within said use prohibition area originates a call to another communication terminal, said user terminal is notified that said user terminal is within said use prohibition area, without connecting said call origination.

15 The home location register defined in claim 12, wherein when a user terminal currently within said use prohibition area originates a call to another communication terminal, said communication terminal, or a call originator, is notified that said user terminal, or a communication destination, is within said use prohibition area, without connecting said call origination.

16 A mobile communication control method wherein mobile communications of a user terminal are controlled, said method comprising the step of:
limiting communications of a user terminal in accordance with a location of said user terminal.

17 The method defined in claim 16, further comprising the steps of:
receiving data about a current location of said user terminal;
referring to a use prohibition area registration table for recording location data about a location within a use prohibition area where communications of said user terminal is not allowed;
referring to a location information management table for recording data about a current location of said user terminal; and
performing a terminal location management wherein said user terminal within said use prohibition area is detected based on data on said use prohibition area registration table and based on data on said location information management table, and control is made such that said user terminal does not communicate within said use prohibition area.

18 The method defined in claim 17, further comprising the step of instructing, when said user terminal currently in a busy state is detected within said use prohibition area, said disconnection processor in said user terminal to disconnect communications.

19 The method defined in claim 18, further comprising the step of notifying, when it is detected that said user terminal currently in a busy state is approaching said use prohibition area, said user terminal of the fact.

20 The method defined in claim 18, further comprising the step of notifying, when a user terminal currently within said use prohibition area originates a call to another communication terminal, said user terminal that said user terminal is within said use prohibition area, without connecting said call origination.

21 The method defined in claim 18, further comprising the step of notifying, when a user terminal currently within said use prohibition area originates a call to another communication terminal, said communication terminal, or a call originator, that said user terminal, or a communication destination, is within said use prohibition area, without connecting said call origination.

22 A communication control program that controls mobile communications of a user terminal by controlling a computer, said program executing the process of limiting communications of a user terminal in accordance with a location of said user terminal.

23 The program defined in claim 22, further comprising the steps of:
receiving data about a current location of said user terminal;
referring to a use prohibition area registration table for recording location data about a location within a use prohibition area where communications of said user terminal is not allowed;
referring to a location information management table for recording data about a current location of said user terminal; and
performing a terminal location management wherein said user terminal within said use prohibition area is detected based on data on said use prohibition area registration table and based on data on said location information management table, and control is made such that said user terminal does not communicate within said use prohibition area.

24 The program defined in claim 23, further comprising the step of instructing, when said user terminal currently in a busy state is detected within said use prohibition area, said disconnection processor in said user terminal to disconnect communications.

25 The program defined in claim 24, further comprising the step of notifying, when it is detected that said user terminal currently in a busy state is approaching said use prohibition area, said user terminal of the fact.

26 The program defined in claim 24, further comprising the step of notifying, when a user terminal currently within said use prohibition area originates a call to another communication terminal, said user terminal that said user terminal is within said use prohibition area, without connecting said call origination.

27 The program defined in claim 24, further comprising the step of notifying, when a user terminal currently within said use prohibition area originates a call to another communication terminal, said communication terminal, or a call originator, that said user terminal, or a communication destination, is within said use prohibition area, without connecting said call origination.

28 A portable communications terminal for mobile communications, comprising:
a disconnection processor for disconnecting communications based on instructions from a communication limiter;
said limiter limiting communications of said portable communications terminal in accordance with a location of said portable communications terminal.

29 The terminal defined in claim 28, further comprising:
a location detector for detecting a current location of said portable communications terminal; and
means for notifying said communication limiter of data about the current location of said communications terminal detected by said location detector.

30 The terminal defined in claim 29, wherein said disconnection processor urges a user to disconnect communications by issuing an alarm when said disconnection processor receives the notice that said terminal is currently approaching said use prohibition area, from said communication limiter in a busy state.

31 The terminal defined in claim 29, wherein said location detector detects a current location of said personal communication terminal, using a global positioning system (GPS).
